(19) United States
(12) Patent Application Publication
(10) Pub. No.: US 2019/0114633 A1
(43) Pub. Date: Apr. 18, 2019

(54) COMPUTER SYSTEM AND COMPUTER-IMPLEMENTED METHOD FOR PROCESSING PAYMENT CARD TRANSACTIONS

(71) Applicant: MASTERCARD INTERNATIONAL INCORPORATED, Purchase, NY (US)

(72) Inventors: Puneet Gandhi, Pune (IN); Arunmurthy Gurunathan, Pune (IN); Navneet Jain, Pune (IN)

(21) Appl. No.: 16/125,365

(22) Filed: Sep. 7, 2018

(30) Foreign Application Priority Data
Oct. 12, 2017 (SG) 10201708440T

(51) Int. Cl. G06Q 20/40

(52) U.S. Cl. CPC G06Q 20/409; G06Q 20/20

(57) ABSTRACT

A payment network server for processing a payment card transaction is described. The server comprises a processor configured to: receive, from an acquirer server, a payment transaction request comprising transaction details and an expiry identifier, where the expiry identifier indicates that the payment card transaction uses an expired payment card and the transaction details comprise expired card data associated with the expired payment card; determine, using a payment network database, if the expired payment card is associated with a reissued payment card; retrieve, from the payment network database, reissued card data associated with the reissued payment card if the expired payment card is associated with the reissued payment card; request authorisation, from an issuer server, to proceed with the payment card transaction using the reissued card data and the transaction details; and transmit, to the acquirer server, a payment transaction response indicating an approval or a refusal for the payment card transaction to proceed.

### CROSS REFERENCING TO RELATED APPLICATION

This application claims the benefit of priority to Singapore Patent Application No. 10201708440T, filed Oct. 12, 2017, entitled “COMPUTER SYSTEM AND COMPUTER-IMPLEMENTED METHOD FOR PROCESSING PAYMENT CARD TRANSACTIONS”, the entirety of which is incorporated herein by reference.

### FIELD OF THE INVENTION

The present invention relates to a computer system and computer-implemented method for processing payment card transactions. In particular, the invention relates to expired payment cards.

### BACKGROUND OF THE INVENTION

At present, expiry dates are mandatory for payment cards to comply with the EMV® standard. Typically, when a payment card (e.g. a credit card, a debit card or a prepaid card) is due to expire, an issuer of the payment card issues a new payment card to a cardholder with a revised expiry date as a replacement card.

From the perspective of the issuer, the re-issuance of payment cards incurs administrative and logistics costs as a result of manufacturing new payment cards and keeping track of, for example, expiry dates of existing payment cards for all registered cardholders. Moreover, manufacturing of new plastic payment cards increases carbon footprints which is an environmental concern.

In addition, if a cardholder of an expired payment card did not receive a new payment card, if the cardholder is unable to activate the new payment card in time or if the new payment card is faulty, the cardholder is left without a valid payment card for payment transactions. This causes inconvenience for the cardholder and is detrimental to his/her user experience.

It is therefore an aim of the present invention to provide computer systems and methods to ameliorate some or all of the aforementioned problems.

### SUMMARY OF THE INVENTION

In accordance with a first aspect of the present invention, there is provided a payment network server for processing a payment card transaction initiated by a cardholder. The server comprising at least a computer processor and a data storage device, the data storage device comprising non-transitory instructions operative by the processor to:
receive, from an acquirer server, a payment transaction request, the payment transaction request comprising transaction details and an expiry identifier, wherein the expiry identifier indicates that the payment card transaction uses an expired payment card and the transaction details comprise expired card data associated with the expired payment card;
determine, using a payment network database, if the expired payment card is associated with a reissued payment card;
retrieve, from the payment network database, reissued card data associated with the reissued payment card if it is determined that the expired payment card is associated with the reissued payment card;
request authorisation, from an issuer server associated with an issuer institution, to proceed with the payment card transaction using the reissued card data and the transaction details; and
transmit, to the acquirer server, a payment transaction response indicating an approval or a refusal for the payment card transaction to proceed.

Embodiments of the invention therefore provide a payment network server that can be used for processing payment card transactions using expired payment cards. In particular, to process a payment card transaction using an expired payment card, the payment network server determines if the expired payment card is associated with a reissued payment card, retrieves reissued card data associated with the reissued payment card and transmits the reissued card data together with the transactions details to an issuer server for authorisation. In this way, the payment network server of the present invention advantageously allows processing of payment card transactions using expired payment cards, thereby improving user experience since disruption in the usage of a payment card is minimised (even if the payment card has expired). Moreover, issuing institutions will have more time to resolve any defaults at their ends and to send reissued payment cards to their respective cardholders.

In addition, embodiments of the invention may advantageously use present infrastructure for processing payment card transactions using expired payment cards so that minimal costs will be incurred to implement the above. The primary set-up required is to maintain records of expired card data and re-issued card data at the issuer server and the payment network server which can be easily implemented using existing memory storages, servers and/or databases.

The payment network server may be configured to:
transmit, to the issuer server, an authorisation request seeking an approval by the issuer server to authorise the payment transaction, the authorisation request comprising the transaction details and the reissued card data; and
receive, from the issuer server, an authorisation response indicating if the payment card transaction is approved or refused to proceed, wherein the authorisation response indicates an approval for the payment card transaction to proceed if the payment card transaction is authenticated by the cardholder via a cardholder electronic device.

This provides a further security feature to ensure that the use of an expired payment card for payment card transactions is authenticated by the cardholder and advantageously minimises fraudulent transactions that may otherwise occur without the knowledge of the cardholder.

In accordance with a second aspect of the present invention, there is provided a computer-implemented method for processing, at a payment network server, a payment card transaction initiated by a cardholder, the method comprising:
receiving, from an acquirer server, a payment transaction request, the payment transaction request comprising transaction details and an expiry identifier, wherein the expiry identifier indicates that the payment card transaction uses an expired payment card and the transaction details comprise expired card data associated with the expired payment card;
determining, using a payment network database, if the expired payment card is associated with a reissued payment card;
retrieving, from the payment network database, reissued card data associated with the reissued payment card if it is determined that the expired payment card is associated with the reissued payment card;
requesting authorisation, from an issuer server associated with an issuer institution, to proceed with the payment card transaction using the reissued card data and the transaction details; and
transmitting, to the acquirer server, a payment transaction response indicating an approval or a refusal for the payment card transaction to proceed.

The method may further comprises:
transmitting, to the issuer server, an authorisation request seeking an approval by the issuer server to authorise the payment transaction, the authorisation request comprising the transaction details and the reissued card data; and
receiving, from the issuer server, an authorisation response indicating if the payment card transaction is approved or refused to proceed, wherein the authorisation response indicates an approval for the payment card transaction to proceed if the payment card transaction is authenticated by the cardholder via a cardholder electronic device.

The authentication of the payment card transaction may comprise verifying a cardholder authentication identifier, the cardholder authentication identifier is selected from one of the following: a personal identification number (PIN), a signature, a biometric identifier, a gesture, a specific voice command or a one-time password (OTP). Preferably, the cardholder authentication identifier comprises a dynamic password. The cardholder authentication identifier may also comprise a combination of passwords, codes, commands and/or gestures selected from the list above.

The authorisation request may comprise the expiry identifier. The expiry identifier may serve to indicate that the authorisation request is associated with a payment transaction using an expired payment card so that the issuer server may proceed with authorising the payment transaction accordingly.

The method may comprise:
receiving, from the issuer server, the reissued card data and the expired card data;
determining if the reissued card data and the expired card data are valid; and
storing, in the payment network database, the reissued card data and expired card data if it is determined that the reissued card data and the expired card data are valid.

The method may comprise:
determining if the issuer institution associated the issuer server and an acquirer institution associated with the acquirer server can be identified in the payment network database; and
transmitting, to the acquirer server, the payment transaction response indicating a refusal to proceed with the payment card transaction if it is determined that the issuer institution and the acquirer institution are not registered in the payment network database;
wherein the issuer institution and the acquirer institution can be identified in the payment network database if the issuer institution and the acquirer institution are registered in the payment network database.

The method may comprise:
determining if a time period between a time at which the expired payment card expired and a time at which the payment transaction request is received is more than a predetermined expiry period threshold; and
transmitting, to the acquirer server, the payment transaction response indicating a refusal to proceed with the payment card transaction if it is determined that the time period is more than the predetermined expiry period threshold.

The predetermined expiry period threshold may be determined by the issuer institution. The predetermined expiry period threshold may be, for example, 1 day, 2 days, 3 days, 5 days, 10 days, 15 days, 30 days, 1 month, 2 months, 3 months, 6 months, 1 year, 2 years, 3 years or 5 years. Different predetermined expiry period thresholds may be set depending on a credit limit of the expired payment card. For example, an expired payment card with a higher credit limit may present a higher financial risk to the issuer and/or the cardholder. In this case, a shorter predetermined expiry period threshold may be desired to minimise the risk. Alternatively, a cardholder possessing an expired payment card with a higher credit may be more valuable to the issuer institution so that the issuer institution may wish to provide a longer predetermined expired period threshold to the cardholder for his/her convenience. The predetermined expiry period may also be determined by the cardholder of the expired payment card.

Preferably, the predetermined expiry period threshold is no more than 3 months to minimise financial risks. This is in line with an aim of the present invention where the computerised system and computerize method provides a solution to tie over a period between a time when a payment card has expired and a time when a reissued payment card can be activated so as to minimise disruptions for using the payment card (even though it has expired) for transactions and to improve user experience.

The method may comprise:
determining if a transaction amount associated with the payment transaction request received is more than a predetermined transaction threshold; and
transmitting, to the acquirer server, the payment transaction response indicating a refusal to proceed with the payment card transaction if it is determined that the transaction amount is more than the predetermined transaction threshold.

The predetermined transaction threshold may be determined by the cardholder or the issuer institution. The predetermined transaction threshold may be, for example, 10 dollars, 20 dollars, 30 dollars, 50 dollars, 100 dollars, 200 dollars, 500 dollars, 1000 dollars, 2000 dollars or 5000 dollars. Different predetermined transaction thresholds may be set depending on corresponding predetermined expiry period thresholds. For example, if the predetermined expiry period threshold is long, the predetermined transaction threshold may be set low so as to minimise financial risks. A cumulative transaction threshold relating to a cumulative total of transaction amounts processed using the expired payment card may also be set. The cumulative transaction threshold limits the total amount which may be spent using the expired payment card and thereby minimises financial risks for the cardholder and/or the issuer institution.

The payment transaction request may be received from either an automated teller machine or a point-of-sale terminal.

In accordance with a third aspect of the present invention, a non-transitory computer-readable medium having stored thereon program instructions for causing at least one processor to perform the preceding method.

The present invention aims to provide a new and useful computer system and computer-implemented method for carrying out payment card transactions using an expired payment card.

### BRIEF DESCRIPTION OF THE DRAWINGS

Non-limiting embodiments of the invention will now be described for the sake of example only, with reference to the following drawings in which:

FIG. 1 shows steps of a computer-implemented method which may be performed by a payment network server in accordance with a first embodiment of the invention;

FIG. 2 shows a computerised network for performing the method of FIG. 1 in accordance with the first embodiment of the invention;

FIG. 3 shows steps of a method for requesting authorisation to proceed with a payment card transaction in accordance with an embodiment of the invention;

FIG. 4 shows steps of a method for processing a payment card transaction in accordance with an embodiment of the invention;

FIG. 5 shows steps of a method for determining if an issuer institution and an acquirer institution are registered in a payment network database in accordance with an embodiment of the invention;

FIG. 6 shows steps of a method for registering with an issuer institution to use an expired payment card for payment card transactions in accordance with an embodiment of the invention;

FIG. 7 shows steps of a method for receiving reissued card data and expired card data at the payment network server in accordance with an embodiment of the invention;

FIG. 8 shows an illustration for receiving the reissued card data and the expired card data in accordance with an embodiment of the invention;

FIG. 9 shows steps of a method which may be performed by the payment network server in accordance with an embodiment of the invention;

FIG. 10 shows steps of a method which may be performed by the payment network server in accordance with an embodiment of the invention;

FIG. 11 shows schematically a functional structure of the payment network server which may be used in the computerised network as shown in FIG. 2 in accordance with an embodiment of the invention; and

FIG. 12 shows schematically a hardware structure of a server which may be used in the computerised network of FIG. 2 to implement a method in accordance with an embodiment of the invention.

### DETAILED DESCRIPTION OF THE EMBODIMENT

As used in this document, the term “payment card” refers to any electronic cashless payment vehicle associated with a payment account, such as a credit card, a debit card, a prepaid card, a charge card, a membership card, a promotional card, a frequent flyer card, an identification card, a prepaid card, a gift card, and/or any other payment device that may hold payment account information, such as mobile phones, Smartphones, personal digital assistants (PDAs), key fobs, transponder devices, NFC-enabled devices, and/or computers.

Note that the term “institution” is used here in a sense which is not necessarily limited to organizations which are legally constituted as banks, since in some jurisdictions other organizations may be permitted to maintain financial accounts such as a payment card account. An institution may be one of the following: a bank, a financial technology company, a telecommunication company or a financial institution.

As used in this application, the terms “component,” “module,” “system,” “apparatus,” “interface,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. For instance, the claimed subject matter may be implemented as a computer-readable medium embedded with a computer executable program, which encompasses a computer program accessible from any computer-readable storage device or storage media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ).

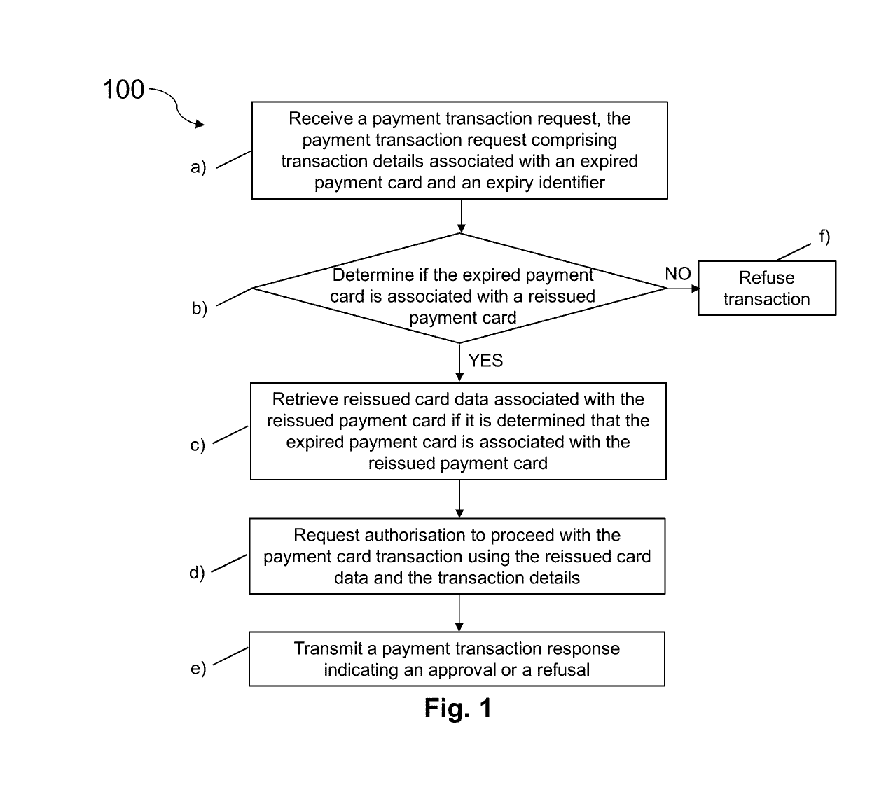

FIG. 1 shows a computer-implemented method 100 which may be performed by a payment network server for processing a payment card transaction using an expired payment card in accordance with a first embodiment of the present invention.

In particular, the payment network server of the computer-implemented method 100 is configured to:
a) receive from an acquirer server, a payment transaction request, the payment transaction request comprising transaction details and an expiry identifier, wherein the expiry identifier indicates that the payment card transaction uses an expired payment card and the transaction details comprise expired card data associated with the expired payment card;
b) determine, using a payment network database, if the expired payment card is associated with a reissued payment card;
c) retrieve, from the payment network database, reissued card data associated with the reissued payment card if it is determined that the expired payment card is associated with the reissued payment card;
d) request authorisation, from an issuer server associated with an issuer institution, to proceed with the payment card transaction using the reissued card data and the transaction details; and
e) transmit, to the acquirer server, a payment transaction response indicating an approval or a refusal for the payment card transaction to proceed.

If the expired payment card is determined not to be associated with any reissued payment card, the payment card transaction will be refused in step f). In this case, the payment card transaction may be reinitiated by a card holder of the expired payment card using another payment card (e.g. either a valid payment card or another expired payment card) or another form of payment.

The expired card data may comprise a payment card number or account number associated with the expired payment card, a name of the cardholder, an expiry date and a card verification code (e.g. CVC2 or CVV). The payment card number or account number may further comprise a bank identification code (BIN).

FIG. 1 thus provides a computer-implemented method 100 which advantageously allows processing of a payment card transaction using an expired payment card, thereby improving user experience since disruption in the usage of a payment card is minimised (even if the payment card has expired).

Moreover, the above method 100 advantageously utilises present infrastructures for payment card transactions so that minimal costs will be incurred to implement the method 100 above. The primary set-up required is to maintain records of expired card data mapped to re-issued card data at the payment network server which can be easily implemented using memory storages, servers and/or databases.

Furthermore, the payment network server serves to allow acquirer institutions and issuer institutions to effectively register with the payment network server for processing payment card transactions using an expired payment card centrally, thereby effectively administering the method 100 with minimal administrative costs to the acquirer institutions and issuer institutions.

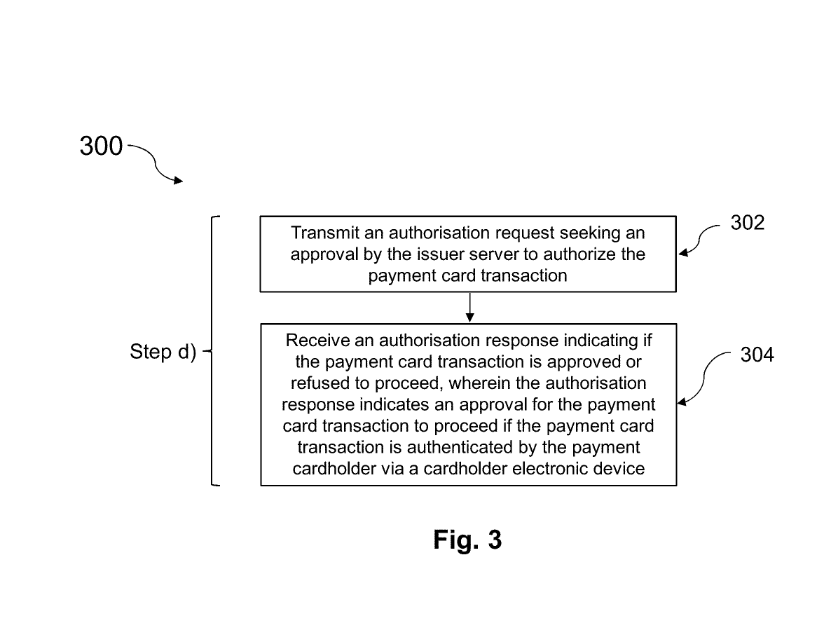

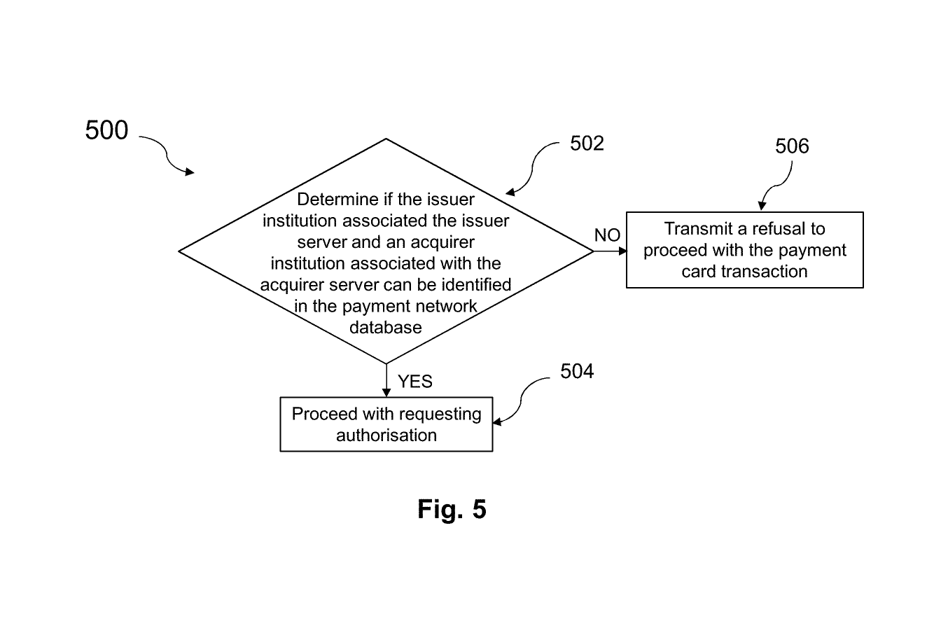

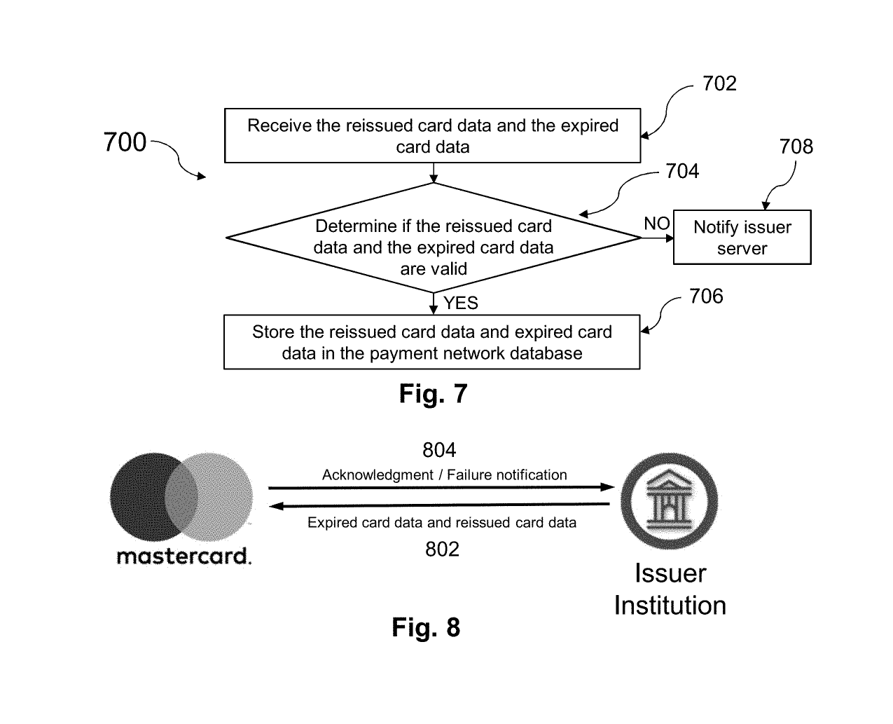

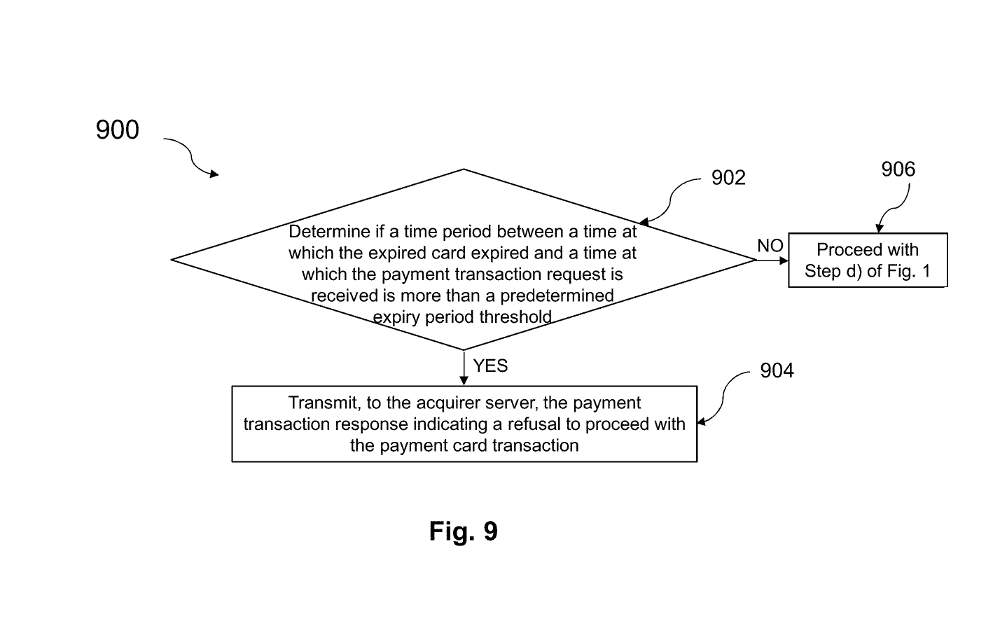

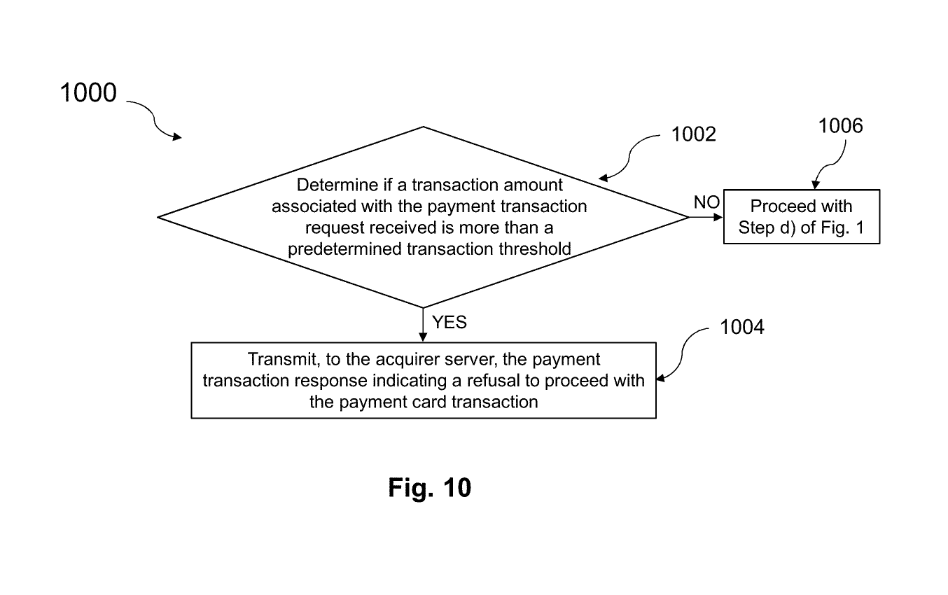

As will be explained in more detail later in FIG. 3, a secondary authorisation from the cardholder of the expired payment card may be required to process the payment card transaction using the expired payment card. Moreover, as detailed in FIG. 5 below, the acquirer institution and the issuer institution are required to register with the payment network server before a payment card transaction using an expired payment card can proceed. Details of how an issuer institution may register with the payment network server is further explained in FIGS. 7 and 8. Furthermore, additional parameters, as will be discussed in FIGS. 9 and 10 below, may be considered by the payment network server before a payment card transaction using an expired payment card can proceed.

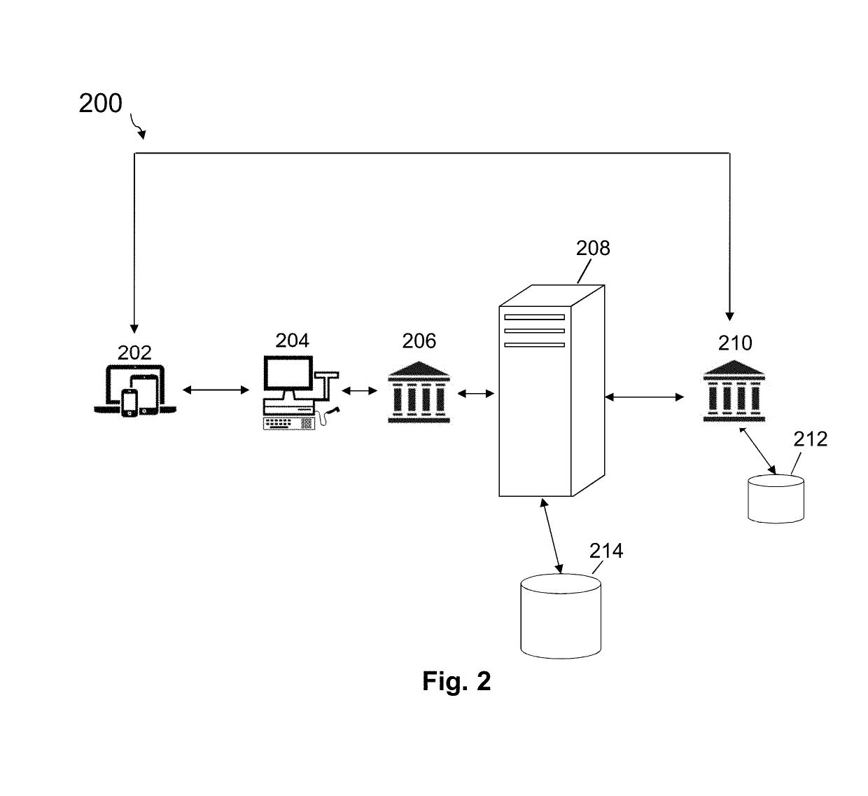

Referring to FIG. 2, a computerised network 200 for performing the method 100 in accordance with the first embodiment of the invention is shown. The computerised network 200 comprises a payment network server 208 which facilitates a payment transaction between a cardholder and a merchant. The payment network server 208 is a server associated with a payment network such as the Banknet payment network operated by MasterCard®. As shown in FIG. 2, the payment network server 208 is in communication with an acquirer server 206 and an issuer server 210. The acquirer server 206 is operated by an acquiring institution at which the merchant maintains an account to receive funds. The issuer server 210 is associated with an issuer institution which maintains payment card accounts and provide payment cards to cardholders for performing payment card transactions over the payment network. The computerised network 200 further comprises a cardholder electronic device 202 and a merchant apparatus 204 (e.g. a Point-of-Sale (POS) terminal or an Automated Teller Machine (ATM) or a merchant website associated with a payment gateway (for simplicity, the payment gateway is not shown), the payment gateway being an entity which would communicate between the merchant website and the acquirer institution for processing payment transactions). In an embodiment, the cardholder electronic device 202 initiates a payment card transaction using an expired payment card at the merchant apparatus 204. For example, the customer may swipe his/her payment card or perform a contactless payment transaction using a cardholder electronic device 202 at the POS terminal or the ATM, or the customer may perform an online transaction at a merchant website in the form of a card-not-present transaction. The merchant apparatus 204 checks the expiry date and associates the payment card transaction with an expiry identifier to notify the acquirer server 206 that the payment card transaction is associated with an expired payment card if it determines that the expiry date has passed, and transmits a payment transaction request to the acquirer server 206 where the payment transaction request comprises the transaction details and the expiry identifier. The transaction details comprise expired card data associated with the expired payment card (e.g. a payment card number or account number associated with the expired payment card, a name of the cardholder, an expiry date and a CVC2 or CVV). The expiry identifier may be a single character or a string of numbers or alphanumeric or letters or codes accompanying the payment transaction request which serves to indicates that the payment card transaction uses an expired payment card. The expiry identifier may be a generic code for all payment card transactions using an expired payment card, or it may be a specific code that includes a generic portion to indicate that it is a payment transaction using an expired payment card and a specific portion that is unique to the expired payment card used for the payment card transaction. After receiving the payment transaction request and the expiry identifier from the merchant apparatus 204, the acquirer server 206 forwards this information to the payment network server 208 for processing the payment card transaction as described previously in the method 100 of FIG. 1.

In another embodiment, a check on the expiry date is performed at the payment network server 208. In this scenario, the merchant apparatus 204 and the acquirer server 206 simply transmit the transaction details to the payment network server 208. The payment network server 208 checks the expiry date of the card data associated with the transaction details and associates the payment card transaction with an expiry identifier if it determines that the expiry date has passed. The payment network server 208 carries out the steps b) to e) as described in the method 100 subsequently to process the payment card transaction.

Although only one cardholder electronic device 202 and only one merchant apparatus 204 is shown in FIG. 2, a plurality of cardholder electronic devices 202 and a plurality of merchant apparatuses 204 associated with respective merchants may also form part of the computerised network 200. Similarly, a plurality of acquirer servers 206 and a plurality of issuer servers 210 may also be in communication with the payment network server 208 and form part of the computerised network 200. Moreover, an issuer database 212 is operationally connected to the issuer server 210. The issuer database 212 serves at least to store expired card data associated with expired payment cards which are mapped to reissued card data associated with reissued payment cards, where the expired payment cards and reissued payment cards were issued by the issuer institution associated with the issuer server 210. As will be explained later in FIGS. 7 and 8, this expired card data and reissued card data is transmitted to the payment network server 208 when the issuer institution registers for processing payment card transactions using expired payment cards and is updated when existing cards expire and new cards are issued. There is also provided a payment network database 214 in communication with the payment network server 208. The payment network database 214 serves at least to store the expired card data and the reissued card data provided by the issuer server 210 for processing payment card transactions using expired payment cards. The payment network database 214 may also store data in regards to payment transactions processed using an expired payment card by the payment network server 208. Moreover, the payment network database 214 may also store predetermined expiry period thresholds and predetermined transaction thresholds associated with expired payment cards as detailed in FIGS. 9 and 10 which will be discussed later. Communication between the servers and databases may take place via any type of network, for example, a virtual private network (VPN), the Internet, a local area and/or wide area network (LAN and/or WAN), and so on.

FIG. 3 shows steps of a method 300 for requesting authorisation to proceed with a payment card transaction in accordance with an embodiment of the invention. The method 300 provides further detail to the step d) of the method 100 in requesting authorisation from the issuer server 210 to proceed with the payment card transaction using an expired payment card.

In a step 302, using the reissued card data retrieved in step c) of the method 100, the payment network server 208 transmits an authorisation request to the issuer server 210 seeking an approval by the issuer server 210 to authorise the payment card transaction. The payment network server 208 may be configured to compile the authorisation request in an ISO 8583 compliant format for transmission of the authorisation request. The authorisation request comprises the transaction details (e.g. expired card data (e.g. a payment card number or account number associated with the expired payment card, a name of the cardholder, an expiry date and a CVC2 or CVV), a transaction amount, a transaction date etc.) and the reissued card data (e.g. a payment card number or account number associated with the reissued payment card, a name of the cardholder, an expiry date and a CVC2 or CVV). In an embodiment, the authorisation request comprises the expiry identifier. The expiry identifier serves to indicate that the authorisation request is associated with a payment transaction using an expired payment card so that the issuer server may proceed with authorising the payment transaction accordingly.

In a step 304, the payment network server 208 receives an authorisation response indicating if the payment card transaction is approved or refused to proceed, where the authorisation response indicates an approval for the payment card transaction to proceed if the payment card transaction is authenticated by the cardholder via the cardholder electronic device 202. The authentication of the payment card transaction comprises verifying a cardholder authentication identifier, where the cardholder authentication identifier may be selected from one of the following: a personal identification number (PIN), a signature, a biometric identifier, a gesture, a specific voice command or a one-time password (OTP). The cardholder authentication identifier may be registered with the issuer server at the time of registering for the expired payment card or it may be provided to the issuer server when the cardholder registers to use an expired payment card for payment transactions. The cardholder authentication identifier may comprise a dynamic password. The cardholder authentication identifier may comprise a combination of passwords, codes, commands and/or gestures selected from the list above. In embodiments, the authorisation response received from the issuer server 210 is also in an ISO 8583 compliant format. The payment network server 208 may be configured to sort the data received in the authorisation response and to identify if the payment card transaction is approved or refused to proceed.

If the issuer server 210 is unable to authenticate the cardholder, the issuer server 210 may be configured to transmit an authorisation response to the payment network server 210 indicating that payment card transaction using the expired payment card is not authorized as a result of the non-authentication by the cardholder. In this case, the payment network server 208 may be configured to transmit a payment transaction response to the acquirer server 206 indicating that the payment transaction is refused. The payment network server 208 may be configured to request for another payment card to be used for the payment transaction where the cardholder may provide details of another payment card (e.g. a valid payment card or another expired payment card) or another form of payment for use in the payment transaction.

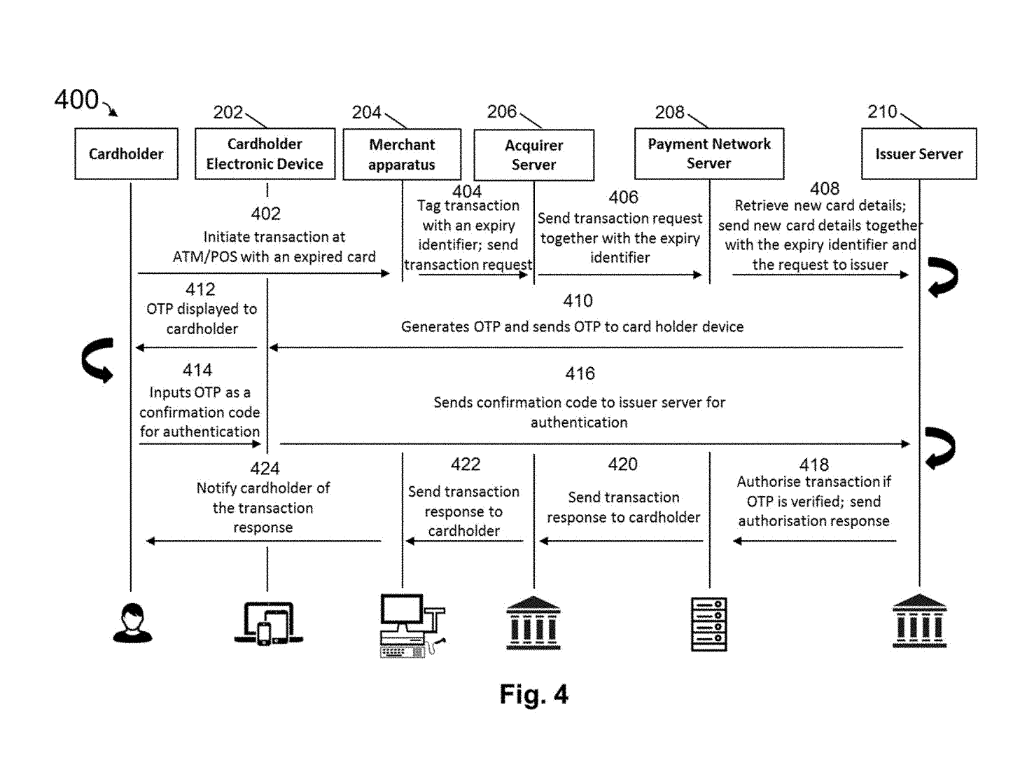

FIG. 4 illustrates an exemplary embodiment for processing a payment card transaction using an expired payment card. Typically, a cardholder may initiate a payment card transaction at a merchant apparatus in a retail location associated with a merchant. The merchant apparatus may be an Automated Teller Machine (ATM) or a Point-of-Sale (POS) terminal. The merchant apparatus 204 may be configured to interact with a cardholder electronic device 202 connected to the computerised network 200 as shown in FIG. 2.

The cardholder initiates a payment transaction request for a payment card transaction using an expired payment card at the merchant apparatus 204 in a step 402. The payment transaction request comprises at least transaction details where the transaction details comprise expired card data associated with the expired payment card. In an embodiment, the merchant apparatus 204 may be configured to identify a payment transaction that uses an expired payment card using the transaction details (e.g. by identifying a payment card expiry date in the transaction details and comparing it with a date on which the payment transaction request is made). In another embodiment, the cardholder is required to specify at the merchant apparatus 204 when initiating the payment transaction request that it is a payment card transaction using an expired payment card. This may be done by selecting an option which may be presented to the cardholder at the time of initiating the payment transaction. In either of the above cases, the merchant apparatus 204 introduces an expiry identifier to be tagged to the payment transaction request once it is identified that the payment transaction request is associated with an expired payment card, where the expiry identifier indicates that the payment card transaction uses an expired payment card. The merchant apparatus 204 then transmits the payment transaction request and the expiry identifier to the acquirer server 206 in a step 404, which the acquirer server 206 forwards the information to the payment network server to be processed in a step 406.

After the payment transaction request is received from the acquirer server 206 at the step 406, the payment network server 208 is configured to determine, using a payment network database 214, if the expired payment card is associated with a reissued payment card, and to retrieve from the payment network database 214 reissued card data associated with the reissued payment card if it is determined that the expired payment card is associated with the reissued payment card (e.g. as shown in the steps b) and c) of the method 100 in FIG. 1). After retrieving the reissued card data from the payment network database 214, the payment network server 208 is configured to request authorisation, from the issuer server 210, to proceed with the payment card transaction using the reissued card data and the transaction details in a step 408. The payment network server 208 may be configured to identify an issuer server for the payment card transaction conventionally e.g. using a BIN associated with the expired payment card.

The expired card data and the reissued card data received as a bundle from the payment network server 208 may act as an indicator to the issuer server 210 that the payment transaction request/authorisation request is associated with a payment card transaction using an expired payment card. In the present embodiment, the expiry identifier is also transmitted from the payment network server 208 to the issuer server 210 at the step 408 to indicate that the authorisation requested is associated with a payment card transaction using an expired payment card. In other embodiments, it may not be necessary for the expiry indicator to be transmitted to the issuer server 210.

The issuer server 210 is configured to generate a one-time password (OTP) to the cardholder once it receives the request for authorisation of the payment transaction using the expired payment card from the payment network server 208 at the step 408. The expiry identifier accompanying the authorisation request may serve to indicate to the issuer server 210 that an authentication from the cardholder is required to proceed with the payment card transaction. The OTP is sent to the cardholder in a step 410. The OTP may be in the form of a barcode, a Quick Response (QR) code, a string of numbers or alphanumeric.

The cardholder receives the OTP via the cardholder electronic device 202 in a step 412. The OTP may be displayed on the cardholder electronic device 202 so that the cardholder may be informed of the OTP. The cardholder electronic device 202 may be a mobile phone, a personal computer, a tablet, a laptop, a key-fob or a personal digital assistant (PDA). The OTP can then be provided as an authentication for the payment card transaction. The cardholder is also notified in the step 412 if he/she would like to complete the payment transaction using the expired payment card with the OTP. In an embodiment, if the cardholder wishes to complete the payment card transaction, the cardholder inputs the OTP into the cardholder electronic device 202 in a step 414 as a confirmation code which is subsequently sent to the issuer server 210 in a step 416. The confirmation code entered by the cardholder serves to authenticate the payment transaction. The cardholder may enter the confirmation code through a mobile banking application on the cardholder electronic device 202 or through an online banking account of the cardholder. In another embodiment (not shown in FIG. 4), the confirmation code is entered at the merchant apparatus 204 by the cardholder. The confirmation code may be transmitted from the cardholder electronic device 202 to the merchant apparatus 204 wirelessly or contactlessly, for example using Near Field Communication (NFC), telecommunications or other protocols. The confirmation code may then be forwarded by the merchant apparatus 204 to the acquirer server 206 and subsequently to the issuer server 210 via the payment network server 208 for further processing.

The issuer server 210 is configured to determine if the confirmation code received in the step 416 matches the OTP sent by the issuer server 210 in the step 410. The payment card transaction is authenticated if it is determined that the confirmation code received from the cardholder matches the OTP sent to the cardholder. In the case that the confirmation code received matches the OTP sent to the cardholder, the payment card transaction is authenticated and an authorisation response to approve the payment card transaction is transmitted to the payment network server 208 in a step 418. Otherwise, in the event that the confirmation code does not match the OTP, the issuer server 210 transmits an authorisation response comprising a refusal to proceed with the payment card transaction to the payment network server 208 and the payment card transaction using the expired payment card is refused.

The payment network server 208 in turn transmits a payment transaction response indicating whether the payment transaction has been authorised to the acquirer server 206 in a step 420. The payment transaction response is then forwarded to the merchant apparatus 204 by the acquirer server 206 in a step 422. Once the payment transaction response is received at the merchant apparatus 204, the cardholder is notified of a result of the transaction by the merchant apparatus 204 in a step 424. The payment card transaction is either completed, or the payment card transaction is refused.

FIG. 5 shows steps of a method 500 which may be performed by the payment network server 208 in accordance with an embodiment of the invention.

In a step 502, the payment network server 208 determines if the issuer institution associated the issuer server 210 and an acquirer institution associated with the acquirer server 206 can be identified in the payment network database 214. The issuer institution and the acquirer institution can be identified in the payment network database 214 if the issuer institution and the acquirer institution are registered in the payment network database 214. The issuer institution and the acquirer institution may be registered in the payment network database 214 by enrolling with the payment network server 208 for processing payment card transactions using expired payment cards. For example, in determining if the issuer institution is registered in the payment network database 214, the payment network server 208 may identify the issuer institution associated with the expired payment card used for the payment card transaction using a bank identification number (BIN) submitted as part of the payment transaction request. The BIN may then be used to compare with existing registration records at the payment network database 214. It may be noted that processing payment card transactions using expired payment cards may be at cost, the costs may be incurred by issuers, cardholders or merchants associated with payment card transactions using expired payment cards.

In a step 504, the payment network server 208 is configured to proceed with requesting authorisation, from the issuer server 210, to proceed with the payment card transaction if it is determined that the issuer institution and the acquirer institution can be identified in the payment network database 214. If it is determined that the issuer institution and the acquirer institution cannot be identified in the payment network database 214, the payment network server 208 is configured to transmit, to the acquirer server 206, the payment transaction response indicating a refusal to proceed with the payment card transaction in a step 506. In this case, the payment network server 208 may request for another form of payment or another payment card to be used for the payment card transaction. In some embodiments, it may be necessary for only one of the issuer institution or acquirer institution to be registered in the payment network database 214 for making transactions with expired payment cards.

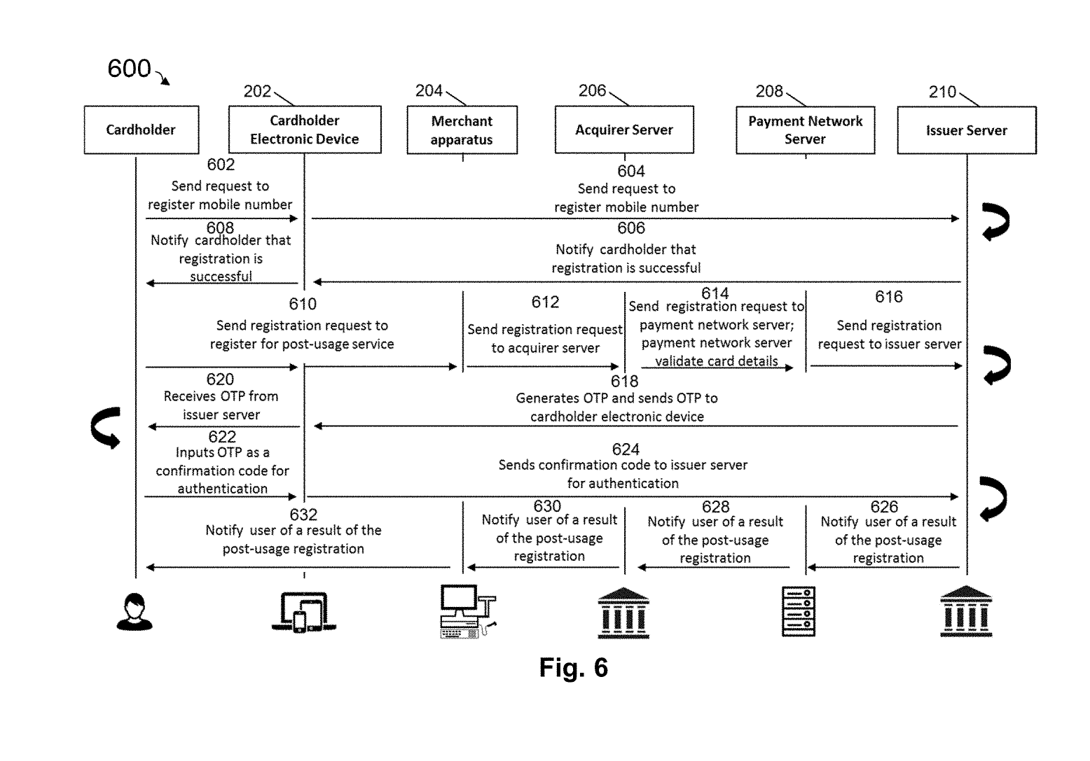

FIG. 6 shows steps of a method for registering with an issuer institution to use an expired payment card for payment card transactions in accordance with an embodiment of the invention. FIG. 6 shows an exemplary embodiment where the cardholder can register to use an expired payment card for payment card transactions at an ATM or a POS terminal of a merchant as will be explained below.

In order to be eligible to use an expired payment card for payment card transactions, the cardholder may be required to register a mobile number associated with the cardholder electronic device 202 with the issuer server 210. An email address or any other form of information which allows the issuer server 210 to contact the cardholder in real-time during a payment card transaction may be used additionally or alternatively. A method of registering e.g. a mobile number with the issuer server 210 is illustrated in steps 602 to 608 of FIG. 6. Preferably, at the time of registering for online banking and/or for mobile banking application on the cardholder electronic device, the cardholder is provided with an option to register the mobile number and/or to register for using an expired payment card for payment card transactions.

In a step 602, a request to register e.g. a mobile number is initiated by the cardholder at the cardholder electronic device 202. The request is then sent to the issuer server 210 via the cardholder electronic device 202. This may be done via an internet banking account of the cardholder or a mobile banking application on the cardholder electronic device 202. The issuer server 210 receives the request and stores the relevant information (e.g. a mobile number of the cardholder) in an issuer database 212 associated with the issuer server 210. Once the registration is complete, the issuer server 210 transmits a notification to the cardholder electronic device 202 to notify the cardholder that the registration is successful in a step 606. The cardholder subsequently notes that the registration of the mobile number is successful via the cardholder electronic device 202 in a step 608.

With the mobile number registered with the issuer server 210, the cardholder may request to register for a post-usage service with the issuer server 210. The request to register a mobile number and to register for the post-usage service may also occur simultaneously. The post-usage service enables the cardholder to use an expired payment card for payment card transactions. In embodiments, only selected cardholders are eligible to register for the post-usage service. The issuer institution may select cardholders based on one of the following: a credit limit associated with the expired payment card, assets owned by the cardholders, and a time period during which the cardholder is associated with the issuer institution.

A method for registering for the post-usage service is illustrated in steps 610 to 638 in FIG. 6 as shown.

In a step 610, the cardholder may choose to register for the post-usage service by initiating a registration request at the merchant apparatus 204 in a step 610. The merchant apparatus 204 maybe an ATM or a POS terminal associated with a merchant. In this way, the cardholder may register to use the post-usage service prior to initiating a payment card transaction at the merchant. The registration request may comprise at least information associated with the cardholder and details associated with the expired payment card for use with the post-usage service.

The merchant apparatus 204 then transmits the registration request to the acquirer server 206 in a step 612, which the acquirer server 206 forwards to the payment network server 208 to be processed in a step 614.

In an embodiment, after the registration request is received from the acquirer server 206 at the step 614, the payment network server 208 is configured to validate details associated with the expired payment card to verify that the details entered are correct. The validation of the details may be done by comparing the details associated with the registration request with details which are stored in the payment network database 114. In this case, the expired payment card is at least associated with the payment network server 208 if the information related to the expired payment card has been previously stored in the payment network database 114. Where the expired payment card is not associated with the payment network server 208, the validation described above may be skipped. In either of these two cases, the registration request is transmitted to the issuer server 210 in a step 616.

The issuer server 210 is configured to generate a one-time password (OTP) for sending to the cardholder once it receives the registration request from the payment network server 208 at the step 616. The OTP is sent to the cardholder in a step 618. The OTP may be in the form of a barcode, a Quick Response (QR) code, a string of numbers or alphanumeric, etc.

The cardholder receives the OTP via the cardholder electronic device 202 in a step 620. The cardholder electronic device 202 may be a mobile phone, a personal computer, a tablet, a laptop, a key-fob or a personal digital assistant (PDA). The OTP can then be provided as an authentication for the registration. In an embodiment, the OTP is inputted into the cardholder electronic device 202 in a step 622 as a confirmation code which is subsequently sent to the issuer server 210 in a step 624. This may be achieved through a mobile banking application on the cardholder electronic device 202 or through an online banking account of the cardholder. In another embodiment (not shown in FIG. 6), the confirmation code may be entered at the merchant apparatus 204 by the cardholder. The confirmation code may be transmitted from the cardholder electronic device 202 to the merchant apparatus 204 wirelessly or contactlessly, for example using Near Field Communication (NFC), telecommunications or other protocols. The confirmation code may then be forwarded by the merchant apparatus 204 to the acquirer server 206, and subsequently to the issuer server 210 via the payment network server 208 for further processing.

The issuer server 210 is configured to determine if the confirmation code received in the step 624 matches the OTP sent by the issuer server 210. The registration is authenticated if it is determined that the confirmation code received from the cardholder matches the OTP sent to the cardholder. In the case that the confirmation code received matches the OTP sent to the cardholder, the registration is authenticated. A result of the post-usage registration to notify the cardholder that the registration is successful is then transmitted by the issuer server 210 to the payment network server 208 in a step 626. Otherwise, if the confirmation code does not match the OTP, the issuer server 210 notifies the cardholder via the payment network server 208 that the registration for the post-usage service is unsuccessful.

The payment network server 208 in turn transmits a registration response indicating whether the registration has been authorised to the acquirer server 206 in a step 628. The registration response is then forwarded to the merchant apparatus 204 by the acquirer server 206 in a step 630. Once the registration response is received at the merchant apparatus 204, the cardholder is notified of a result of the registration by the merchant apparatus 204 in a step 632.

FIG. 7 shows steps of a method 700 for receiving reissued card data and expired card data at the payment network server 208 in accordance with an embodiment of the invention. The method 700 may be carried out when the cardholder is registered at the issuer server 210 for the post-usage service.

In a step 702, the payment network server 208 is configured to receive, from the issuer server 210, reissued card data associated with a reissued payment card and expired card data associated with an expired payment card, where the expired payment card is registered with the post-usage service described in FIG. 6 for use in payment card transactions. In an embodiment, the reissued payment card is a replacement card issued by the issuing institution associated with the issuer server 210 to replace an existing payment card, where the existing payment may be the expired payment card, or a payment card which is due to expire. The reissued card data may comprise a name of the cardholder, a payment card number, an expiry date, a card verification code associated with the reissued payment card. Similarly, the expired card data may comprise a name of the cardholder, a payment card number, an expiry date, a card verification code associated with the expired payment card. In some embodiments, the name of the cardholder, the payment card number and/or the card verification code for the reissued payment card are the same as those for the expired payment card such that only the expiry date for the reissued payment card is different from that for the expired payment card. In other embodiments, more details may be different. The reissued card data and the expired card data may be received from the issuer server 210 by the payment network server 208 in a specific file format. In embodiments, a same standard file format is used for all issuer institutions which have registered with the payment network server for processing payment card transactions using an expired payment card. The standard file format advantageously enables quick interpretation of transaction data. It also enables real time processing which saves time and efforts for the issuer institutions and the payment network. The specific file format may also provide additional security in the transmission of data between the two servers.

In a step 704, the payment network server 208 is configured to determine if the reissued card data and the expired card data are valid. To check the validity of the reissued card data and the expired card data, a number of parameters may be used. For example, the payment network server 208 may be configured to 1) verify the data format of the reissued card data and the expired card data received; 2) validate the reissued card data and the expired card data received against existing data associated with the reissued payment card (if available) and the expired payment card respectively; and/or 3) validate common data fields between the reissued card data and the expired card data (e.g. cardholder's name; mailing address; issuer details; payment card number etc.).

If it is determined that the reissued card data and the expired card data are valid, the payment network 208 is configured to store the reissued card data and the expired card data in the payment network database 214 in a step 706. An acknowledgement that the reissued card data and the expired card data have been safely stored is then transmitted to the issuer server 210. This indicates that payment transactions associated with the expired payment card may now be carried out.

If it is determined that the reissued card data and the expired card data are not valid, the payment network server 208 is configured to transmit a failure notification to the issuer server 210 to notify the issuer server 210 that the reissued card data and the expired card data have not been successfully stored. In this case, the issuer server 210 may reinitiate transmission of the reissued card data and the expired card data to the payment network server 208.

FIG. 8 shows an illustration for receiving the reissued card data and the expired card data in accordance with an embodiment of the invention. For example, the payment network server 208 is a server associated with a payment network such as the Banknet payment network operated by MasterCard®. Once a cardholder has registered for the post-usage service of using an expired payment card for processing payment card transactions, an issuer institution initiates, via an issuer server 210, transmission of expired card data associated with the expired payment card and reissued card data associated with a reissued payment card to the payment network server 208 in a step 802. Upon receiving this data from the issuer server 210, the payment network server 208 is configured to perform the method 700 as detailed above, and transmit to the issuer server 210 either an acknowledgement that the reissued card data and the expired card data have been safely received or a failure notification that the reissued card data and the expired card data are not valid in a step 804.

FIG. 9 shows additional steps which may be performed by the payment network server 208 of FIG. 2 in accordance with an embodiment of the invention. The method 900 may be carried out to further enhance security of a payment card transaction using an expired payment card.

In a step 902, the payment network server 208 is configured to determine if a time period between a time at which the expired payment card expired and a time at which the payment transaction request is received is more than a predetermined expiry period threshold. The predetermined expiry period threshold may be defined by the issuer server 210. The predetermined expiry period threshold may be communicated to the payment network server 208 when the issuer server 210 is registered at the payment network database 112 for processing payment transactions using expired payment cards. The predetermined expiry period threshold may be a generic threshold determined by the issuer institution or it may be a specific threshold uniquely associated with the cardholder or the expired payment card. If the predetermined expiry period threshold is a specific threshold associated with the cardholder or the expired payment card, it may be determined by the cardholder or the issuer institution. The predetermined expiry period threshold may be, for example, 1 day, 2 days, 3 days, 5 days, 10 days, 15 days, 30 days, 1 month, 2 months, 3 months, 6 months, 1 year, 2 years, 3 years or 5 years. Preferably, the predetermined expiry period threshold is no more than 3 months. Different predetermined expiry period thresholds may be set depending on a credit limit of the expired payment card. For example, an expired payment card with a higher credit limit may present higher financial risks to the issuer and/or the cardholder and so a shorter predetermined expiry period threshold may be introduced. Alternatively, a cardholder possessing an expired payment card with a higher credit may be more valuable to the issuer. In this case, the issuer institution may wish to provide a longer predetermined expired period threshold to the cardholder.

In a step 904, the payment network server 208 is configured to transmit, to the acquirer server 206, the payment transaction response indicating a refusal to proceed with the payment card transaction if it is determined that the time period is more than the predetermined expiry period threshold. In this case, the cardholder may be requested to provide alternative form of payment or another payment card to complete the payment card transaction.

In a step 906, if it is determined the time period is not more than the predetermined expiry period threshold, the payment network server 208 is configured to proceed with requesting authorisation of the payment card transaction (see e.g. step d) of FIG. 1).

FIG. 10 shows additional steps which may be performed by the payment network server 208 of FIG. 2 in accordance with an embodiment of the invention. The method 1000 may be carried out in combination with the method 900 in FIG. 9 to further improve security of payment card transactions using an expired payment card.

In a step 1002, the payment network server 208 is configured to determine if a transaction amount associated with the payment transaction request received is more than a predetermined transaction threshold. The predetermined transaction threshold may be defined by the issuer server 210 and is communicated to the payment network server 208 when the issuer server 210 is registered at the payment network database 214 for processing payment transactions using expired payment cards. The predetermined transaction threshold may be a generic threshold determined by the issuer institution or it may be a specific threshold uniquely associated with the cardholder or the expired payment card. If the predetermined transaction threshold is a specific threshold associated with the cardholder or the expired payment card, it may be determined by the cardholder or the issuer institution. The predetermined transaction threshold may be, for example, 10 dollars, 20 dollars, 30 dollars, 50 dollars, 100 dollars, 200 dollars, 500 dollars, 1000 dollars, 2000 dollars or 5000 dollars. Different predetermined transaction thresholds may be set depending on the predetermined expiry period threshold. For example, if the predetermined expiry period threshold is long (e.g. more than 3 months), the predetermined transaction threshold may be set low (e.g. less than $500) so as to minimise financial risks. A cumulative transaction threshold relating to a cumulative total of transaction amounts processed using the expired payment card may also be set. The cumulative transaction threshold limits the total amount which may be spent using the expired payment card and thereby minimises financial risks for the cardholder and/or the issuer.

In a step 1004, the payment network server 208 is configured to transmit, to the acquirer server 206, the payment transaction response indicating a refusal to proceed with the payment card transaction if it is determined that the transaction amount is more than the predetermined transaction threshold. In this case, the cardholder may be requested to provide an alternative form of payment or another payment card to complete the payment card transaction.

In a step 1006, if it is determined the transaction amount is not more than the predetermined transaction threshold, the payment network server 208 is configured to proceed with requesting authorisation of the payment card transaction (see e.g. step d) of FIG. 1).

It is noted that the method 900 in FIG. 9 and the method 1000 in FIG. 10 may be carried out in parallel and the results of which may be used in combination to determine if the payment transaction using the expired payment card should proceed.

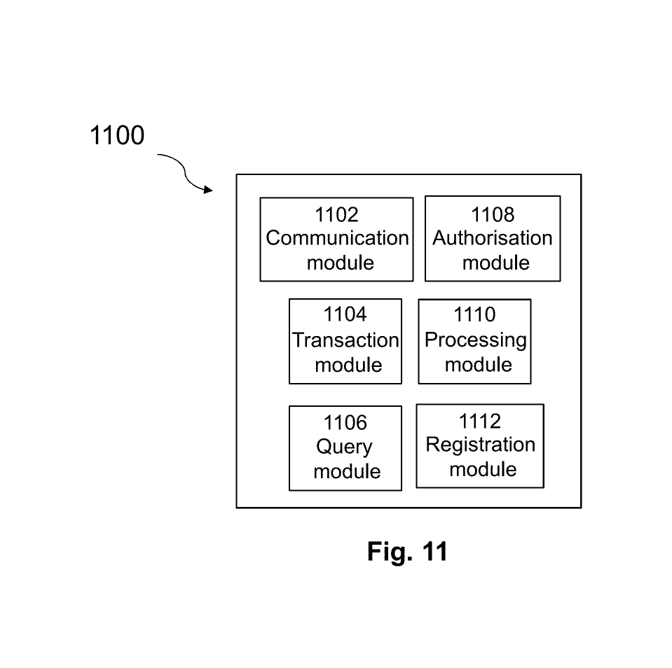

FIG. 11 shows schematically a structure 1100 of the payment network server 208 comprised in the computerised network 200 in accordance with embodiments of the invention. The structure 1100 of the payment network server 208 comprises a communication module 1102, a transaction module 1104, a query module 1106, an authorisation module 1108, a processing module 1110 and a registration module 1112.

The communication module 1102 is configured to enable the payment network server 208 to communicate with at least an acquirer server 206 and an issuer server 210 as provided in the computerised network 200. The communication module 1102 is configured to work in tandem with other modules of the payment network server 206 as discussed in more detail below.

The transaction module 1104 is configured to allow the payment network server 208 to process a payment transaction request. In other words, the transaction module 1104 is configured at least to receive, via the communication module 1102 from an acquirer server 206, a payment transaction request comprising transaction details and an expiry identifier; and to transmit, via the communication module 1102 to the acquirer server 206, a payment transaction response indicating an approval or a refusal for the payment card transaction to proceed. In particular, the transaction module 1104 identifies and sorts the information in the transaction details for use in further processes (e.g. determining step b), retrieving step c), and authorisation step d) of FIG. 1 etc.). The transaction module 1104 may transmit the relevant information isolated from the payment transaction request to other modules of the payment network server 208 for further processing.

The query module 1106 is configured to communicate, via the communication module 1102, with a payment network database 214 to retrieve reissued card data associated with an reissued payment card if it is determined that an expired payment card associated with the payment transaction request is associated with the reissued payment card. In other words, the query module 1106 may be configured to carry out step c) as shown in FIG. 1. Moreover, the query module 1106 may be configured to determine if an issuer institution associated an issuer server 210 and an acquirer institution associated with the acquirer server 206 can be identified in the payment network database 214, and to transmit, in conjunction with the transaction module 1104 and via the communication module 1102, a payment transaction response indicating a refusal to proceed with the payment card transaction to the acquirer server 206 if it is determined that the issuer institution and the acquirer institution cannot be identified in the payment network database 214.

The authorisation module 1108 is configured to transmit, via the communication module 1102 to the issuer server 210, an authorisation request seeking an approval by the issuer server 210 to authorise the payment card transaction, and to receive, via the communication module 1102 from the issuer server 210, an authorisation response indicating if the payment card transaction is approved or refused to proceed.

The processing module 1110 is configured, in conjunction with the query module 1106 and using the payment network database 214, to: a) determine, if the expired payment card is associated with a reissued payment card (e.g. step b) of FIG. 1); and b) determine if the issuer institution associated the issuer server 210 and/or an acquirer institution associated with the acquirer server 206 can be identified. The processing module 1110 may also be configured to determine if a time period between a time at which the expired payment card expired and a time at which the payment transaction request is received is more than a predetermined expiry period threshold (e.g. step 902 of FIG. 9), and to determine if a transaction amount associated with the payment transaction request received is more than a predetermined transaction threshold (e.g. step 1002 of FIG. 10).

The registration module 1112 is configured to register issuer institutions and/or acquirer institutions with the payment network database 214. In some embodiments, a request may be received from an issuer institution via an issuer server 210 or an acquirer institution via an acquirer server 206 to register for the post-usage service with the payment network database 214. Upon receipt of the registration request, the registration module 1112 may be configured to communicate, via the communication module 1102, with the payment network database 214 to register the issuer institution or the acquirer institution at the payment network database 214. The registration module 1112 may also be configured to receive, from the issuer server 210 via the communication module 1102, reissued card data associated with a reissued payment card and expired card data associated with an expired payment card for use in processing payment card transactions using the expired payment card. In receiving the reissued card data and the expired card data, the registration module 1112 may be configured to determine, in conjunction with the query module 1106 and the payment network database 214, if the reissued card data and the expired card data are valid. If it is determined that the reissued card data and the expired card data are valid, the registration module 1112 is configured to store, via the communication module 1102, the reissued card data and expired card data in the payment network database 214.

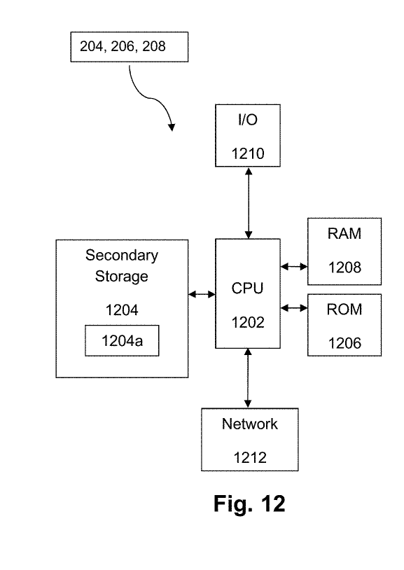

FIG. 12 is a block diagram showing a technical architecture of the payment network server 208. The issuer server 210 and/or the acquirer server 206 may also have this technical architecture.

The technical architecture includes a processor 1202 (which may be referred to as a central processor unit or CPU) that is in communication with memory devices including secondary storage 1204 (such as disk drives), read only memory (ROM) 1206, and random access memory (RAM) 1208. The processor 1202 may be implemented as one or more CPU chips. The technical architecture may further comprise input/output (I/O) devices 1210, and network connectivity devices 1212.

The secondary storage 1204 is typically comprised of one or more disk drives or tape drives and is used for non-volatile storage of data and as an over-flow data storage device if RAM 1208 is not large enough to hold all working data. Secondary storage 1204 may be used to store programs which are loaded into RAM 1208 when such programs are selected for execution.

In this embodiment, the secondary storage 1204 has a processing component 1204a comprising non-transitory instructions operative by the processor 1202 to perform various operations of the method of the present disclosure. The ROM 1206 is used to store instructions and perhaps data which are read during program execution. The secondary storage 1204, the RAM 1208, and/or the ROM 1206 may be referred to in some contexts as computer readable storage media and/or non-transitory computer readable media.

I/O devices 1210 may include printers, video monitors, liquid crystal displays (LCDs), plasma displays, touch screen displays, keyboards, keypads, switches, dials, mice, track balls, voice recognizers, card readers, paper tape readers, or other input devices.

The network connectivity devices 1212 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other network devices. These network connectivity devices 1212 may enable the processor 1212 to communicate with the Internet or one or more intranets. With such a network connection, it is contemplated that the processor 1202 might receive information from the network, or might output information to the network in the course of performing the above-described method operations. Such information, which is often represented as a sequence of instructions to be executed using processor 1202, may be received from and outputted to the network, for example, in the form of a computer data signal embodied in a carrier wave.

The processor 1202 executes instructions, codes, computer programs, scripts which it accesses from hard disk, floppy disk, optical disk (these various disk based systems may all be considered secondary storage 1204), flash drive, ROM 1206, RAM 1208, or the network connectivity devices 1212. While only one processor 1202 is shown, multiple processors may be present. Thus, while instructions may be discussed as executed by a processor, the instructions may be executed simultaneously, serially, or otherwise executed by one or multiple processors.

Although the technical architecture is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture to provide the functionality of a number of servers that is not directly bound to the number of computers in the technical architecture. In an embodiment, the functionality disclosed above may be provided by executing an application and/or applications in a cloud computing environment. Cloud computing may comprise providing computing services via a network connection using dynamically scalable computing resources. A cloud computing environment may be established by an enterprise and/or may be hired on an as-needed basis from a third party provider.

It is understood that by programming and/or loading executable instructions onto the technical architecture, at least one of the CPU 1202, the RAM 1208, and the ROM 1206 are changed, transforming the technical architecture in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

Whilst the foregoing description has described exemplary embodiments, it will be understood by those skilled in the art that many variations of the embodiments can be made within the scope of the present invention as defined by the claims. Moreover, features of one or more embodiments may be mixed and matched with features of one or more other embodiments.

1. A payment network server for processing a payment card transaction initiated by a cardholder, the server comprising at least a computer processor and a data storage device, the data storage device comprising non-transitory instructions operative by the processor to:
receive, from an acquirer server, a payment transaction request, the payment transaction request comprising transaction details and an expiry identifier, wherein the expiry identifier indicates that the payment card transaction uses an expired payment card and the transaction details comprise expired card data associated with the expired payment card;
determine, using a payment network database, if the expired payment card is associated with a reissued payment card;
retrieve, from the payment network database, reissued card data associated with the reissued payment card if it is determined that the expired payment card is associated with the reissued payment card;
request authorisation, from an issuer server associated with an issuer institution, to proceed with the payment card transaction using the reissued card data and the transaction details; and
transmit, to the acquirer server, a payment transaction response indicating an approval or a refusal for the payment card transaction to proceed.

2. The server of claim 1, wherein the processor is further configured to:
transmit, to the issuer server, an authorisation request seeking an approval by the issuer server to authorise the payment card transaction, the authorisation request comprising the transaction details, and the reissued card data; and
receive, from the issuer server, an authorisation response indicating if the payment card transaction is approved or refused to proceed, wherein the authorisation response indicates an approval for the payment card transaction to proceed if the payment card transaction is authenticated by the cardholder via a cardholder electronic device.

3. The server of claim 2, wherein the authentication of the payment card transaction comprises verifying a cardholder authentication identifier, the cardholder authentication identifier is selected from one of the following: a personal identification number (PIN), a signature, a biometric identifier, a gesture, a specific voice command or a one-time password (OTP).

4. The server of claim 2, wherein the authorisation request further comprises the expiry identifier.

5. The server of claim 1, wherein the processor is further configured to:
receive, from the issuer server, the reissued card data and the expired card data;
determine if the reissued card data and the expired card data are valid; and
store, in the payment network database, the reissued card data and expired card data if it is determined that the reissued card data and the expired card data are valid.

6. The server of claim 1, wherein the processor is further configured to:
determine if the issuer institution associated the issuer server and an acquirer institution associated with the acquirer server can be identified in the payment network database; and
transmit, to the acquirer server, the payment transaction response indicating a refusal to proceed with the payment card transaction if it is determined that the issuer institution and the acquirer institution cannot be identified in the payment network database;
wherein the issuer institution and the acquirer institution can be identified in the payment network database if the issuer institution and the acquirer institution are registered in the payment network database.

7. The server of claim 1, wherein the processor is further configured to:
determine if a time period between a time at which the expired payment card expired and a time at which the payment transaction request is received is more than a predetermined expiry period threshold; and
transmit, to the acquirer server, the payment transaction response indicating a refusal to proceed with the payment card transaction if it is determined that the time period is more than the predetermined expiry period threshold.

8. The server of claim 1, wherein the processor is further configured to:
determine if a transaction amount associated with the payment transaction request received is more than a predetermined transaction threshold; and
transmit, to the acquirer server, the payment transaction response indicating a refusal to proceed with the payment card transaction if it is determined that the transaction amount is more than the predetermined transaction threshold.

9. The server of claim 1, wherein the payment transaction request is received from one of the following: an automated teller machine or a point-of-sale terminal.

10. A computer-implemented method for processing, at a payment network server, a payment card transaction initiated by a cardholder, the method comprising:
receiving, from an acquirer server, a payment transaction request, the payment transaction request comprising transaction details and an expiry identifier, wherein the expiry identifier indicates that the payment card transaction uses an expired payment card and the transaction details comprise expired card data associated with the expired payment card;
determining, using a payment network database, if the expired payment card is associated with a reissued payment card;
retrieving, from the payment network database, reissued card data associated with the reissued payment card if it is determined that the expired payment card is associated with the reissued payment card;
requesting authorisation, from an issuer server associated with an issuer institution, to proceed with the payment card transaction using the reissued card data and the transaction details; and
transmitting, to the acquirer server, a payment transaction response indicating an approval or a refusal for the payment card transaction to proceed.

11. The method of claim 10, wherein the step of requesting authorisation further comprises:
transmitting, to the issuer server, an authorisation request seeking an approval by the issuer server to authorise the payment transaction, the authorisation request comprising the transaction details and the reissued card data; and
receiving, from the issuer server, an authorisation response indicating if the payment card transaction is approved or refused to proceed, wherein the authorisation response indicates an approval for the payment card transaction to proceed if the payment card transaction is authenticated by the cardholder via a cardholder electronic device.

12. The method of claim 11, wherein the authentication of the payment card transaction comprises verifying a cardholder authentication identifier, the cardholder authentication identifier is selected from one of the following: a personal identification number (PIN), a signature, a biometric identifier, a gesture, a specific voice command or a one-time password (OTP).

13. The method of claim 11, wherein the authorisation request further comprises the expiry identifier.

14. The method of claim 10, further comprising:
receiving, from the issuer server, the reissued card data and the expired card data;
determining if the reissued card data and the expired card data are valid; and
storing, in the payment network database, the reissued card data and expired card data if it is determined that the reissued card data and the expired card data are valid.

15. The method of claim 10, further comprising:
determining if the issuer institution associated the issuer server and an acquirer institution associated with the acquirer server can be identified in the payment network database; and
transmitting, to the acquirer server, the payment transaction response indicating a refusal to proceed with the payment card transaction if it is determined that the issuer institution and the acquirer institution are not registered in the payment network database;
wherein the issuer institution and the acquirer institution can be identified in the payment network database if the issuer institution and the acquirer institution are registered in the payment network database.

16. The method of claim 10, further comprising:
determining if a time period between a time at which the expired payment card expired and a time at which the payment transaction request is received is more than a predetermined expiry period threshold; and
transmitting, to the acquirer server, the payment transaction response indicating a refusal to proceed with the payment card transaction if it is determined that the time period is more than the predetermined expiry period threshold.

17. The method of claim 16 wherein the predetermined expiry period threshold is no more than 3 months.

18. The method of claim 10, further comprising:
determining if a transaction amount associated with the payment transaction request received is more than a predetermined transaction threshold; and
transmitting, to the acquirer server, the payment transaction response indicating a refusal to proceed with the payment card transaction if it is determined that the transaction amount is more than the predetermined transaction threshold.

19. The method of claim 10, wherein the payment transaction request is received from one of the following: an automated teller machine or a point-of-sale terminal.

20. A non-transitory computer-readable medium having stored thereon program instructions that, upon execution by a processor, cause the processor to at least:
receive, from an acquirer server, a payment transaction request, the payment transaction request comprising transaction details and an expiry identifier, wherein the expiry identifier indicates that the payment card transaction uses an expired payment card and the transaction details comprise expired card data associated with the expired payment card;
determine, using a payment network database, if the expired payment card is associated with a reissued payment card;
retrieve, from the payment network database, reissued card data associated with the reissued payment card if it is determined that the expired payment card is associated with the reissued payment card;
request authorisation, from an issuer server associated with an issuer institution, to proceed with the payment card transaction using the reissued card data and the transaction details; and
transmit, to the acquirer server, a payment transaction response indicating an approval or a refusal for the payment card transaction to proceed.
